(19) United States
(12) Patent Application Publication
(10) Pub. No.: US 2024/0263022 A1
(43) Pub. Date: Aug. 8, 2024

(54) AQUEOUS COATING COMPOSITION

(71) Applicant: Omya International AG, Oftringen (CH)

(72) Inventors: Fabien Wilhelm MONNARD, Aarburg (CH); Jan Philipp WEIHS, Düdingen (CH)

(73) Assignee: Omya International AG, Oftringen (CH)

(21) Appl. No.: 18/566,377

(22) PCT Filed: Jun. 1, 2022
(86) PCT No.: PCT/EP2022/064839

§ 371 Date: Dec. 1, 2023

(30) Foreign Application Priority Data
Jun. 2, 2021 (EP) 21177432.8

(51) Int. Cl. C09D 5/16; C09D 5/00; C09D 7/62; C09D 7/65; C09D 123/08; D21H 19/38; D21H 19/40; D21H 19/58; D21H 19/82; D21H 21/16

(52) U.S. Cl. CPC C09D 5/1668; C09D 5/002; C09D 7/62; C09D 7/65; C09D 123/0876; D21H 19/385; D21H 19/40; D21H 19/58; D21H 19/822; D21H 21/16

(57) ABSTRACT

The invention relates to an aqueous coating composition, a process for preparing the same, and a coated article. The aqueous coating composition comprises (a) a polymer A comprising units derived from an alpha-olefin and one or more comonomers selected from the group of methacrylates, acrylates, methacrylic acid, acrylic acid, maleates, maleic acid, maleic anhydride, and salts thereof; (b) a polymer B comprising units derived from one or more monomers selected from the group of methacrylates, acrylates, methacrylic acid, acrylic acid, maleates, maleic acid, maleic anhydride, and salts thereof; (c) at least one pigment in an amount in the range of 0.1 to 30 wt. %, based on the total dry weight of the coating composition, the at least one pigment being selected from the group consisting of clay minerals, silicates, brucite, magnesium carbonate, barite, perlite, satin white, gypsum, aluminum oxide, titanium dioxide, surface-reacted calcium carbonates, and mixtures thereof; (d) optionally wax.

The present invention relates to an aqueous coating composition and a process for preparing the same. The invention further relates to an article which is coated with the aqueous coating composition, such as a paper or paperboard, and which is useful as packaging for beverages and/or food.

### BACKGROUND

Cellulose-based packaging materials such as paper, paper board, card board etc, for beverages or food are becoming more important as replacements or alternatives for traditional plastic containers. Paper-based products have to fulfill certain requirements to be useful as packaging material for beverage or food, and to be eventually accepted by industry and customer for such purposes. For example, paper-based packaging usually has to have certain minimum water and water vapor barrier properties. Certain minimum values in cold and hot water absorption tests (also known as COBB tests) and water vapor transmissions rates (WVTR) need to be achieved. Additionally, packaging must be grease or oil resistant. Further, paper-based packaging often has to be sealable or heat-sealable to form structures such as cups or containers or to provide such structures with lids or other type of sealing.

Raw paper or fiber substrates most often cannot fulfill any of the above requirements from the packaging sector. This is the reason why raw paper is usually laminated or extrusion-coated with a polymer film, e.g. PE film, to impart one or more of the desired functionalities to the paper. While polymer film lamination may improve functionality of paper as packaging material, it usually complicates recyclability of the cellulosic components of the packaging. This is mainly due to the comparatively high lamination weight of the polymer film. Water-based coating composition can improve recycling over conventional polymer films. However, coatings prepared from water-based compositions, often cannot simultaneously provide a paper substrate with all desired properties (e.g. barrier properties against hot and cold water, and oil; sealability; recyclability, etc.) while maintaining processability and cost-effectiveness. For example, some coatings may not sufficiently withstand hot tea, coffee or other hot beverages, which limits their use in e.g. coffee-to-go cups.

Hence, there is a continuous need in the art for aqueous coating compositions which can provide cellulose-based substrates for packaging with improved properties, especially improved hot water barrier properties, while maintaining processability and cost-effectiveness.

One object of the present invention is to provide an improved aqueous coating composition and an improved article which is coated therewith.

### SUMMARY OF INVENTION

One aspect of the present invention relates to an aqueous coating composition. The aqueous coating composition comprises
(a) a polymer A comprising units derived from an alpha-olefin and one or more comonomers selected from the group of methacrylates, acrylates, methacrylic acid, acrylic acid, maleates, maleic acid, maleic anhydride, and salts thereof;
(b) a polymer B comprising units derived from one or more monomers selected from the group of methacrylates, acrylates, methacrylic acid, acrylic acid, maleates, maleic acid, maleic anhydride, and salts thereof;
(c) at least one pigment in an amount in the range of 0.1 to 30 wt. %, based on the total dry weight of the coating composition, wherein the at least one pigment is selected from the group consisting of clay minerals, silicates, brucite, magnesium carbonate, barite, perlite, satin white, gypsum, aluminum oxide, titanium dioxide, surface-reacted calcium carbonates, and mixtures thereof; and
(d) optionally a wax.

The present invention is based on the combination of at least one pigment as defined herein with an aqueous polymeric composition. The presence of the at least one pigment in the coating composition can improve the properties of a coating prepared from such coating composition. Specifically, the aqueous coating composition of the invention provides an article, preferably a paper article, with a coating that has an excellent overall balance of sealability, cold and hot water COBB, WVTR. For example, the coating has a good hot water stability. Thereby, the inventive coating composition is particularly useful for paper-based packaging which has to resist hot liquids such as cups for hot beverages or food containers which are heated to prepare the food within.

It has further been found that an article comprising the inventive coating can be better processed in hot air sealing machines than a comparable coating without one or more of the specific pigments. In particular, a coated article according to the invention shows less blocking in the coating machine and the sealing machine.

Another aspect of the present invention relates to a process for preparing the aqueous coating composition according to the invention. The process comprises the steps of:
providing an aqueous composition I comprising polymer A and optionally a wax,
providing an aqueous composition II comprising polymer B and optionally a wax,
providing the at least one pigment as defined herein,
mixing the aqueous compositions I and II and the at least one pigment as defined herein.

Another aspect of the present invention relates to a coated article. The coated article comprises a substrate, wherein at least one surface of the substrate comprises a coating prepared from an aqueous coating composition according to the invention.

Preferred embodiments of the invention are defined in the subclaims.

According to one embodiment of the present invention, the at least one pigment is at least one pigment selected from the group of phyllosilicates, preferably from the group consisting of talc, kaolin, mica, montmorillonite, and combinations thereof.

According to one embodiment of the present invention, the at least one pigment is at least one surface-reacted calcium carbonate. According to one embodiment of the present invention, the surface-reacted calcium carbonate is a reaction product of natural ground calcium carbonate or precipitated calcium carbonate, preferably natural ground calcium carbonate, with carbon dioxide and one or more H₃O⁺ ion donor, wherein the carbon dioxide is formed in situ by the H₃O⁺ ion donor treatment and/or is supplied from an external source, and wherein one or more H₃O⁺ ion donor is selected from the group consisting of hydrochloric acid, sulphuric acid, sulphurous acid, phosphoric acid, citric acid, oxalic acid, acetic acid, formic acid, and mixtures thereof, preferably from the group consisting of hydrochloric acid, sulphuric acid, sulphurous acid, phosphoric acid, oxalic acid, H₂PO₄⁻, being at least partially neutralised by a corresponding cation such as Li⁺, Na⁺ or K⁺, HPO₄²⁻, being at least partially neutralised by a corresponding cation such as Li⁺, Na⁺, K⁺, Mg²⁺, or Ca²⁺ and mixtures thereof, more preferably from the group consisting of hydrochloric acid, sulphuric acid, sulphurous acid, phosphoric acid, oxalic acid, or mixtures thereof, and most preferably, the one or more H₃O⁺ ion donor is phosphoric acid. In one specific embodiment, the surface-reacted calcium carbonate is a reaction product of natural ground calcium carbonate and phosphoric acid.

According to one embodiment of the present invention, the aqueous coating composition comprises polymer A and polymer B in a weight ratio of 50:50 to 99:1, and preferably >65:<35 to 99:1.

According to one embodiment of the present invention, the aqueous coating composition comprises 60 to 99.9 wt. %, preferably 75 to 99.9 wt. %, of a combined amount of polymers A and B, based on the total dry weight of the coating composition.

According to one embodiment of the present invention, the aqueous coating composition comprises the at least one pigment in an amount of 0.1 to below 20 wt. %, preferably of 0.1 to 12.5 wt. %, based on the total dry weight of the coating composition.

According to one embodiment of the present invention, the aqueous coating composition comprises:
(a) 50 to 99, preferably >65 to 95, parts per weight of polymer A,
(b) 1 to 50, preferably 5 to <35, parts per weight of polymer B,
(c) 1 to 30, preferably 1 to <20, parts per weight of the at least one pigment, and
(d) optionally 1 to 15, preferably 5 to 12, parts per weight of wax.

According to one embodiment of the present invention, the polymer A comprises, preferably consists of, units derived from an alpha-olefin, preferably ethylene, and one or more monomers selected from the group of methacrylates, acrylates, methacrylic acid, acrylic acid, and salts thereof, and/or the polymer B comprises, preferably consists of, units derived from one or more, preferably two to four, monomers selected from the group of methacrylates, acrylates, methacrylic acid, acrylic acid, and salts thereof.

According to one embodiment of the present invention, the polymer A is a copolymer of ethylene and acrylic acid.

According to one embodiment of the present invention, polymer A has a comonomer content, preferably an acrylic acid content, in the range from 0.5 to 25 mol-%, and preferably from 5 to 25 mol-%.

According to one embodiment of the present invention, polymer A has a comonomer content, preferably an acrylic acid content, in the range from 5 to 30 wt. %.

According to one embodiment of the present invention, the polymer B is a polymer of acrylic acid and from one to three C₁-C₆ alkyl acrylate and/or C₁-C₆ alkyl methacrylate monomers.

According to one embodiment of the present invention, the wax is a hydrocarbon wax, preferably a paraffin wax.

According to one embodiment of the present invention, the aqueous coating composition has a solids content in the range of 5 to 70 wt. %, and preferably of 20 to 60 wt. %, and/or the aqueous coating composition has a pH value in the range of 7.5 to 12, and preferably 8 to 11.

According to one embodiment of the present invention, the substrate is a cellulose-based substrate, a plastic or a metal, preferably a cellulose-based substrate, and more preferably a paper, a paper board, or a card board.

According to one embodiment of the present invention, the coated article comprises a pre-coating between the at least one surface of the substrate and the coating, wherein the pre-coating comprises at least one mineral and a binder.

For purposes of the present invention, the following terms have the following meanings:

A “polymer comprising units derived from” a specific monomer means that the polymer is obtained by polymerizing at least the specific monomer (e.g. methacrylate, methacrylic acid, etc).

“Methacrylate” describes an ester of methacrylic acid and “acrylate” an ester of acrylic acid. “Maleate” describes a mono- or diester (preferably diester) of maleic acid.

The “particle size” of particulate materials herein is described by its distribution of particle sizes dₓ. Unless specified otherwise, the value dₓ represents the diameter relative to which x % by weight of the particles have diameters less than dₓ. This means that, for example, the d₂₀ value is the particle size at which 20 wt.-% of all particles are smaller than that particle size. The d₅₀ value is thus the weight median particle size, i.e. 50 wt.-% of all particles are smaller than this particle size. For the purpose of the present invention, the particle size is specified as weight median particle size d₅₀(wt.) unless indicated otherwise. Particle sizes may be determined by using a Sedigraph™ 5120 instrument of Micromeritics Instrument Corporation. The method and the instrument are known to the skilled person and are commonly used to determine the particle size of fillers and pigments. The measurements may be carried out in an aqueous solution of 0.1 wt.-% Na₄P₂O₇.

A “surface-reacted calcium carbonate” in the meaning of the present invention is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source.

The “particle size” of surface-reacted calcium carbonate herein is described as volume-based particle size distribution dₓ(vol). Therein, the value dₓ(vol) represents the diameter relative to which x % by volume of the particles have diameters less than dₓ(vol). This means that, for example, the d₂₀(vol) value is the particle size at which 20 vol. % of all particles are smaller than that particle size. The d₅₀(vol) value is thus the volume median particle size, i.e. 50 vol. % of all particles are smaller than that particle size and the d₉₈(vol) value, referred to as volume-based top cut, is the particle size at which 98 vol. % of all particles are smaller than that particle size.

Volume median particle size d₅₀ may be evaluated using a Malvern Mastersizer 3000 Laser Diffraction System. The d₅₀ or d₉₈ value, measured using a Malvern Mastersizer 3000 Laser Diffraction System, indicates a diameter value such that 50% or 98% by volume, respectively, of the particles have a diameter of less than this value. The raw data obtained by the measurement are analysed using the Mie theory, with a particle refractive index of 1.57 and an absorption index of 0.005.

Where an indefinite or definite article is used when referring to a singular noun, e.g., “a”, “an” or “the”, this includes a plural of that noun unless anything else is specifically stated. Where the term “comprising” is used in the present description and claims, it does not exclude other elements.

For the purposes of the present invention, the term “consisting of” and “essentially consisting of” is considered to be a preferred embodiment of the term “comprising”. If hereinafter a group is defined to comprise at least a certain number of embodiments, this is also to be understood to disclose a group, which preferably consists only of these embodiments or essentially consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined hereinabove.

### DETAILED DESCRIPTION

In the following, the aspects and embodiments of the present invention are described in more detail.

### Aqueous Coating Composition and Process for Preparing the Same

In one aspect, the invention relates to an aqueous coating composition. The aqueous coating composition comprises
(a) a polymer A comprising units derived from an alpha-olefin and one or more comonomers selected from the group of methacrylates, acrylates, methacrylic acid, acrylic acid, maleates, maleic acid, maleic anhydride, and salts thereof;
(b) a polymer B comprising units derived from one or more monomers selected from the group of methacrylates, acrylates, methacrylic acid, acrylic acid, maleates, maleic acid, maleic anhydride, and salts thereof;
(c) at least one pigment in an amount in the range of 0.1 to 30 wt. %, based on the total dry weight of the coating composition, wherein the at least one pigment is selected from the group consisting of clay minerals, silicates, brucite, magnesium carbonate, barite, perlite, satin white, gypsum, aluminum oxide, titanium dioxide, surface-reacted calcium carbonates, and mixtures thereof; and
(d) optionally a wax.

### Polymer A

The aqueous coating composition according to the invention comprises a polymer A comprising units derived from an alpha-olefin and one or more (e.g. one to three) comonomers selected from the group of methacrylates, acrylates, methacrylic acid, acrylic acid, maleates, maleic acid, maleic anhydride, and salts thereof.

The alpha-olefin is preferably a C₂-C₄ alpha-olefin, and most preferably ethylene.

Suitable methacrylates may be alkyl methacrylates, optionally a C₁-C₆-alkyl methacrylates such as methyl methacrylate or butyl methacrylate.

Suitable acrylates may be alkyl acrylates, optionally C₁-C₆-alkyl acrylates such as methyl acrylate or butyl acrylate.

Suitable maleates may be dialkyl maleates, optionally di-C₁-C₆-alkyl maleates.

According to one preferred embodiment, polymer A comprises, preferably consists of, units derived from an alpha-olefin, preferably ethylene, and one or more (e.g. one to three) comonomers selected from the group of methacrylates, acrylates, methacrylic acid, acrylic acid, and salts thereof.

Polymer A can have a specific comonomer content. Preferably, polymer A has a comonomer content (methacrylates, acrylates, methacrylic acid, maleates, maleic acid, maleic anhydride, and/or acrylic acid) in the range from 0.5 to 25 mol-%, preferably from 5 to 25 mol-%, more preferably from 15 to 25 mol-%, like in the range from 15 to 22 mol-%.

In another preferred embodiment, polymer A has a comonomer content (methacrylates, acrylates, methacrylic acid, maleates, maleic acid, maleic anhydride, and/or acrylic acid) in the range from 5 to 25 mol-% (e.g. 8 to 22 mol-%), more preferably from 5 to 15 mol-%, even more preferably from 5 to 12 mol-%, like in the range of 8 to 12 mol-%.

Polymer A may be present in partially or fully neutralized form. “Neutralized” means in the context of polymers A and B that a carboxylic acid group of polymer units derived from methacrylic acid and/or acrylic acid is neutralized by mono-, di-, and/or trivalent cations, such as alkali cations (e.g. Li⁺, Na⁺, NH₄⁺). According to one embodiment, polymer A is present in partially neutralized form. According to one preferred embodiment, polymer A is present in fully neutralized form.

According to one preferred embodiment, polymer A is a polymer of ethylene and acrylic acid, and optionally methacrylic acid. Most preferably, polymer A is a copolymer of ethylene and acrylic acid. The copolymer of ethylene and acrylic acid preferably can have a comonomer content of acrylic acid in the range of in the range from 0.5 to 30 mol-%, preferably from 5 to 25 mol-%, more preferably from 15 to 25 mol-%, like in the range of from 15 to 22 mol-%. For example, the acrylic acid-content of the ethylene-acrylic acid-copolymer may be about 20 mol-%. The ethylene-acrylic acid copolymer can have a weight amount of acrylic acid in the range of 5 to 30 wt. %, preferably 10 to 25 wt. %, and more preferably 12 to 20 wt. %.

The copolymer of ethylene and acrylic acid preferably can have a comonomer content of acrylic acid in the range of in the range from 5 to 25 mol-% (e.g. 8 to 22 mol-%), more preferably from 5 to 15 mol-%, even more preferably from 5 to 12 mol-%, like in the range of 8 to 12 mol-%. For example, the acrylic acid-content of the ethylene-acrylic acid-copolymer may be about 10 mol-%.

A suitable ethylene-acrylic acid copolymer has the CAS no. 9010-77-9.

Polymer A can be present in the aqueous coating composition in a weight amount of 55 to 98 wt. %, preferably 60 to 85 wt. %, more preferably 60 to 80 wt. % (e.g. 60 to 70 wt. %), based on the total dry weight of the coating composition.

### Polymer B

The aqueous coating composition according to the invention comprises a polymer B comprising units derived from one or more (e.g. one to five) monomers selected from the group of methacrylates, acrylates, methacrylic acid, acrylic acid, maleates, maleic acid, maleic anhydride, and salts thereof.

It is to be understood that polymer A and polymer B are different polymers, which means for this invention that at least one polymer unit in polymer A is different from the polymer unit(s) in polymer B.

Suitable methacrylate monomers are methyl methacrylate, butyl methacrylate, hexyl methacrylate, isobutyl methacrylate, isopropyl methacrylate, sec-butyl methacrylate, cyclohexyl methacrylate, isodecyl methacrylate, isobornyl methacrylate, t-butylaminoethyl methacrylate, stearyl methacrylate, glycidyl methacrylate, dicyclopentenyl methacrylate, and phenyl methacrylate. Preferred methacrylate monomers are methyl methacrylate, butyl methacrylate, hexyl methacrylate, isobutyl methacrylate, isopropyl methacrylate. More preferred methacrylate monomers are butyl methacrylate and methyl methacrylate.

Suitable acrylate monomers are methyl acrylate, ethyl acrylate, butyl acrylate, hexyl acrylate, 2-ethylhexyl acrylate, octyl acrylate and isooctyl acrylate, n-decyl acrylate, isodecyl acrylate, tert-butyl acrylate, and 2-hydroxyethyl acrylate. Preferred acrylate monomers are methyl acrylate, ethyl acrylate, butyl acrylate, hexyl acrylate, 2-ethylhexyl acrylate, octyl acrylate and isooctyl acrylate, n-decyl acrylate, isodecyl acrylate, tert-butyl acrylate, and 2-hydroxyethyl acrylate. More preferred acrylate monomers are methyl acrylate, ethyl acrylate, butyl acrylate, 2-ethylhexyl acrylate, octyl acrylate, and isooctyl acrylate.

Suitable maleates are dialkyl maleates, optionally di-C1-C6-alkyl maleates.

Polymer B can be present in partially or fully neutralized form. According to one embodiment, the first polymer is present in partially neutralized form. According to one preferred embodiment, the first polymer is present in fully neutralized form.

According to one embodiment, polymer B comprises units derived from one or more (e.g. from one to five) monomers selected from the group of alkyl methacrylates, alkyl acrylates, methacrylic acid, acrylic acid, dialkyl maleates, maleic acid, maleic anhydride, and salts thereof. According to one embodiment, polymer B comprises units derived from one or more (e.g. from one to five) monomers selected from the group of alkyl methacrylates, alkyl acrylates, methacrylic acid, acrylic acid, and salts thereof. According to one preferred embodiment, polymer B comprises units derived from one or more, preferably two to four, monomers selected from the group of C₁-C₆-alkyl methacrylates, C₁-C₆-alkyl acrylates, methacrylic acid, acrylic acid, di-C₁-C₆ alkyl maleates, maleic acid, maleic anhydride, and salts thereof. According to one preferred embodiment, polymer B comprises units derived from one or more, preferably two to four, monomers selected from the group of C₁-C₆-alkyl methacrylates, C₁-C₆-alkyl acrylates, methacrylic acid, acrylic acid, and salts thereof. According to one preferred embodiment, polymer B comprises units derived from one to five, preferably two to four, monomers selected from the group of C₁-C₆-alkyl methacrylates, C₁-C₆-alkyl acrylates, methacrylic acid, acrylic acid, and salts thereof.

According to one embodiment, polymer B comprises, preferably consists of, units derived from one or more, preferably two to four, monomers selected from the group of alkyl methacrylates, alkyl acrylates, methacrylic acid, acrylic acid, and salts thereof. According to one preferred embodiment, polymer B consists of units derived from one or more, preferably two to four, monomers selected from the group of C₁-C₆-alkyl methacrylate, C₁-C₆-alkyl acrylate, methacrylic acid, acrylic acid, and salts thereof. According to one preferred embodiment, polymer B consists of units derived from one to five, preferably two to four, monomers selected from the group of C₁-C₆-alkyl methacrylates, C₁-C₆-alkyl acrylates, methacrylic acid, acrylic acid, and salts thereof.

According to one preferred embodiment of the invention, polymer B is a polymer of acrylic acid and from one to three acrylate and/or methacrylate monomers. According to one preferred embodiment of the invention, polymer B is a polymer of acrylic acid and from one to three alkyl acrylate and/or alkyl methacrylate monomers. According to one preferred embodiment of the invention, polymer B is a polymer of acrylic acid and from one to three C₁-C₆-alkyl acrylate and/or C₁-C₆-alkyl methacrylate monomers.

According to one more preferred embodiment, polymer B is a polymer of acrylic acid, butyl acrylate, butyl methacrylate and methyl methacrylate. A suitable polymer B has the CAS no. 51981-89-6.

According to another embodiment, polymer B is an acrylic acid-acrylate copolymer, preferably an acrylic acid-C₁-C₆-alkyl acrylate copolymer.

Polymer B can be present in the aqueous coating composition in a weight amount of 1 to 30 wt. %, preferably 5 to 25 wt. %, more preferably 10 to 25 wt. % (e.g. 15 to 25 wt. %), based on the total dry weight of the coating composition.

### The at Least One Pigment

The aqueous coating composition according to the invention comprises at least one pigment selected from the group consisting of clay minerals, silicates, brucite, magnesium carbonate, barite, perlite, satin white, gypsum, aluminum oxide, titanium dioxide, aluminum oxide, surface-reacted calcium carbonates, and mixtures thereof.

The at least one pigment is present in the aqueous coating composition in a weight amount of 0.1 to 30 wt. %, based on the total dry weight of the coating composition. For example, the at least one pigment may be present in an amount of 0.1 to below 20 wt. %, optionally 0.1 to 12.5 wt. %, optionally 2 to 12.5 wt. %, optionally 2 to 8 wt. % (e.g. 3 to 8 wt. % or 5 to 8 wt. %), based on the total dry weight of the coating composition.

The at least one pigment can have a weight median particle size d₅₀ in the range of 0.1 to 15 microns, optionally 0.1 to 10 microns, and optionally 0.1 to 5 microns. Further, the at least one pigment can have a weight-based top cut particle size of in the range of 0.1 to 30 microns, optionally 0.1 to 20 microns, and optionally 0.1 to 10 microns, and optionally 0.1 to 5 microns.

The at least one pigment may be a clay mineral or a mixture of clay minerals. Suitable clay minerals may be, but are not limited to, kaolin, serpentinite, talc, vermiculite, montmorillonite, and mixtures thereon. The one or more clay minerals can have a weight median particle size d50 in the range of 0.1 to 15 microns, optionally 0.1 to 10 microns, and optionally 0.1 to 5 microns. Further, the one or more clay mineral can have a weight-based top cut particle size of in the range of 0.1 to 30 microns, optionally 0.1 to 20 microns, and optionally 0.1 to 10 microns, and optionally 0.1 to 5 microns.

The at least one pigment may be a silicate. Suitable silicates may be, but are not limited to, silicon dioxide, precipitated silica, fumed silica, phyllosilicates (e.g. kaolin, talc, micas), and mixtures thereof.

According to one embodiment of the present invention, the at least one pigment is at least one phyllosilicate. Suitable phyllosilicates may be selected from kaolin, metakaolin, talc, mica, chlorite, pyrophyllite, montmorillonite, serpentine, bentonite, and mixtures thereof. Preferably, the at least one phyllosilicate is a kaolin, talc, mica, montmorillonite, or a combination thereof.

The talc may be macrocrystalline talc, microcrystalline talc, or a combination thereof. The talc may be natural talc, synthetic talc, or a mixture thereof. Natural talc may comprise talc derived from a natural resource, e.g., natural talc deposits. Talc may comprise, for example, hydrated magnesium silicate of formula Si₄Mg₃O₁₀(OH)₂, e.g., arranged as a stack of laminae, and/or chlorite (hydrated magnesium aluminum silicate).

The kaolin may be used in a processed or unprocessed form, and may be derived from a natural source, e.g., a natural kaolin clay deposit The kaolin may contain from about 50% to about 100% by weight of kaolinite (Al₂Si₂O₅(OH)₄), e.g., from about 50% to about 95%, from about 50% to about 90%, from about 70% to about 100%, from about 70% to about 90%, or from about 80% to about 100%, by weight of kaolinite. In one embodiment, the kaolinite is partially or fully calcined.

The at least one silicate, preferably phyllosilicate, can have a weight median particle size d₅₀ in the range of 0.1 to 15 microns, optionally 0.1 to 10 microns, and optionally 0.1 to 5 microns. Further, the one or more clay mineral can have a weight-based top cut particle size of in the range of 0.1 to 30 microns, optionally 0.1 to 20 microns, and optionally 0.1 to 10 microns, and optionally 0.1 to 5 microns.

The at least one phyllosilicate may have a specific shape factor. As used herein, shape factor refers to a measure of an average value (on a weight average basis) of the ratio of mean particle diameter to particle thickness for a population of particles of varying size and shape. Shape factor may be measured using the electrical conductivity method and apparatus described in U.S. Pat. No. 5,576,617. In this method, the electrical conductivity of a fully dispersed aqueous suspension of the particles is measured as they flow through an elongated tube. Measurements of the electrical conductivity are taken between (a) a pair of electrodes separated from one another along the longitudinal axis of the tube, and (b) a pair of electrodes separated from one another across the transverse width of the tube. The shape factor of the particulate material is determined from the difference between these two conductivity measurements. Higher shape factors generally describe more platy materials. The minerals may have a shape factor of at least 2 (for e.g. bentonites), at least 10, at least 20, at least 40, at least 60, at least 80, at least 90, at least 100, at least 120, or at least 200. In some cases, the minerals may have a shape factor ranging from 10 to 200, e.g., from 20 to 200, from 20 to 100, from 40 to 100, from 20 to 80, from 20 to 60, or from 40 to 60.

The at least pigment may be a magnesium carbonate. It is appreciated that the term “magnesium carbonate” refers to a material that comprises at least 80 wt.-% magnesium carbonate, e.g. at least 85 wt.-%, preferably between 85 and 100 wt.-%, more preferably between 90 and 99.95 wt.-%, based on the total dry weight of the material.

The magnesium carbonate can be a naturally occurring or synthetic magnesium carbonate. For example, the magnesium carbonate encompasses naturally occurring or synthetic magnesium carbonate selected from the group comprising magnesite (MgCO₃), hydromagnesite (Mg₅(CO₃)₄(OH)₂·4H₂O), artinite (Mg₂(CO₃)(OH)₂·3H₂O), dypingite (Mg₅(CO₃)₄(OH)₂·5H₂O), giorgiosite (Mg₅(CO₃)₄(OH)₂·5H₂O), pokrovskite (Mg₂(CO₃)(OH)₂·0.5H₂O), barringtonite (MgCO₃·2H₂O), lansfordite (MgCO₃·5H₂O), nesquehonite (MgCO₃·3H₂O) and mixtures thereof.

In one embodiment, the magnesium carbonate comprises synthetic hydromagnesite (Mg₅(CO₃)₄(OH)₂·4H₂O). Preferably, the magnesium carbonate comprises synthetic hydromagnesite (Mg₅(CO₃)₄(OH)₂·4H₂O) in an amount of at least 80 wt.-%, more preferably at least 85 wt.-%, even more preferably between 85 and 100 wt.-%, and most preferably between 90 and 99.95 wt.-%, based on the total dry weight of the material.

The magnesium carbonate may have a specific surface area of ≥25 m²/g, measured using nitrogen and the BET method according to ISO 9277:2010. It is preferred that the magnesium carbonate has a specific surface area in the range from 25 to 150 m²/g, more preferably from 35 to 120 m²/g, and most preferably from 35 to 100 m²/g, measured using nitrogen and the BET method according to ISO 9277:2010.

The magnesium carbonate may be in the form of a particulate material, and may have a particle size distribution as conventionally employed for the material(s) involved in the type of product to be produced. In general, it is preferred that the magnesium carbonate has a d₅₀(volume-based) in the range from 1 to 75 μm, as determined by laser diffraction. For example, the magnesium carbonate has a d₅₀(vol) in the range from 1.2 to 50 μm, more preferably from 1.5 to 30 μm, even more preferably from 1.7 to 15 μm and most preferably from 1.9 to 10 μm, as determined by laser diffraction.

Additionally or alternatively, the magnesium carbonate has a d₉₈(vol) in the range from 2 to 150 μm, as determined by laser diffraction. For example, the magnesium carbonate has a d₉₈(vol) in the range from 4 to 100 μm, more preferably from 6 to 80 μm, even more preferably from 8 to 60 μm and most preferably from 10 to 40 μm, as determined by laser diffraction.

The at least one pigment may be a surface-reacted calcium carbonate. The surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source.

A H₃O⁺ ion donor in the context of the present invention is a Brønsted acid and/or an acid salt.

In a preferred embodiment of the invention the surface-reacted calcium carbonate is obtained by a process comprising the steps of: (a) providing a suspension of natural or precipitated calcium carbonate, (b) adding at least one acid having a pKₐ value of 0 or less at 20° C. or having a pKₐ value from 0 to 2.5 at 20° C. to the suspension of step (a), and (c) treating the suspension of step (a) with carbon dioxide before, during or after step (b). According to another embodiment the surface-reacted calcium carbonate is obtained by a process comprising the steps of: (A) providing a natural or precipitated calcium carbonate, (B) providing at least one water-soluble acid, (C) providing gaseous CO₂, (D) contacting said natural or precipitated calcium carbonate of step (A) with the at least one acid of step (B) and with the CO₂ of step (C), characterised in that: (i) the at least one acid of step B) has a pKₐ of greater than 2.5 and less than or equal to 7 at 20° C., associated with the ionisation of its first available hydrogen, and a corresponding anion is formed on loss of this first available hydrogen capable of forming a water-soluble calcium salt, and (ii) following contacting the at least one acid with natural or precipitated calcium carbonate, at least one water-soluble salt, which in the case of a hydrogen-containing salt has a pKₐ of greater than 7 at 20° C., associated with the ionisation of the first available hydrogen, and the salt anion of which is capable of forming water-insoluble calcium salts, is additionally provided.

“Natural ground calcium carbonate” (GCC) preferably is selected from calcium carbonate containing minerals selected from the group comprising marble, chalk, limestone and mixtures thereof. Natural calcium carbonate may comprise further naturally occurring components such as alumino silicate etc.

In general, the grinding of natural ground calcium carbonate may be a dry or wet grinding step and may be carried out with any conventional grinding device, for example, under conditions such that comminution predominantly results from impacts with a secondary body, i.e. in one or more of: a ball mill, a rod mill, a vibrating mill, a roll crusher, a centrifugal impact mill, a vertical bead mill, an attrition mill, a pin mill, a hammer mill, a pulveriser, a shredder, a de-clumper, a knife cutter, or other such equipment known to the skilled man. In case the calcium carbonate containing mineral material comprises a wet ground calcium carbonate containing mineral material, the grinding step may be performed under conditions such that autogenous grinding takes place and/or by horizontal ball milling, and/or other such processes known to the skilled man. The wet processed ground calcium carbonate containing mineral material thus obtained may be washed and dewatered by well-known processes, e.g. by flocculation, filtration or forced evaporation prior to drying. The subsequent step of drying (if necessary) may be carried out in a single step such as spray drying, or in at least two steps. It is also common that such a mineral material undergoes a beneficiation step (such as a flotation, bleaching or magnetic separation step) to remove impurities.

“Precipitated calcium carbonate” (PCC) in the meaning of the present invention is a synthesized material, generally obtained by precipitation following reaction of carbon dioxide and calcium hydroxide in an aqueous environment or by precipitation of calcium and carbonate ions, for example CaCl₂) and Na₂CO₃, out of solution. Further possible ways of producing PCC are the lime soda process, or the Solvay process in which PCC is a by-product of ammonia production. Precipitated calcium carbonate exists in three primary crystalline forms: calcite, aragonite and vaterite, and there are many different polymorphs (crystal habits) for each of these crystalline forms. Calcite has a trigonal structure with typical crystal habits such as scalenohedral (S-PCC), rhombohedral (R-PCC), hexagonal prismatic, pinacoidal, colloidal (C-PCC), cubic, and prismatic (P-PCC). Aragonite is an orthorhombic structure with typical crystal habits of twinned hexagonal prismatic crystals, as well as a diverse assortment of thin elongated prismatic, curved bladed, steep pyramidal, chisel shaped crystals, branching tree, and coral or worm-like form. Vaterite belongs to the hexagonal crystal system. The obtained PCC slurry can be mechanically dewatered and dried.

According to one embodiment of the present invention, the precipitated calcium carbonate is precipitated calcium carbonate, preferably comprising aragonitic, vateritic or calcitic mineralogical crystal forms or mixtures thereof.

Precipitated calcium carbonate may be ground prior to the treatment with carbon dioxide and at least one H₃O⁺ ion donor by the same means as used for grinding natural calcium carbonate as described above.

According to one embodiment of the present invention, the natural or precipitated calcium carbonate is in form of particles having a weight median particle size d₅₀ of 0.05 to 10.0 μm, preferably 0.2 to 5.0 μm, more preferably 0.4 to 3.0 μm, most preferably 0.6 to 1.2 μm, especially 0.7 μm. According to a further embodiment of the present invention, the natural or precipitated calcium carbonate is in form of particles having a top cut particle size d₉₈ of 0.15 to 55 μm, preferably 1 to 40 μm, more preferably 2 to 25 μm, most preferably 3 to 15 μm, especially 4 μm.

The natural and/or precipitated calcium carbonate may be used dry or suspended in water. Preferably, a corresponding slurry has a content of natural or precipitated calcium carbonate within the range of 1 wt.-% to 90 wt.-%, more preferably 3 wt.-% to 60 wt.-%, even more preferably 5 wt.-% to 40 wt.-%, and most preferably 10 wt.-% to 25 wt.-% based on the weight of the slurry.

The one or more H₃O⁺ ion donor used for the preparation of surface reacted calcium carbonate may be any strong acid, medium-strong acid, or weak acid, or mixtures thereof, generating H₃O⁺ ions under the preparation conditions. According to the present invention, the at least one H₃O⁺ ion donor can also be an acidic salt, generating H₃O⁺ ions under the preparation conditions.

According to one embodiment, the at least one H₃O⁺ ion donor is a strong acid having a pKₐ of 0 or less at 20° C.

According to another embodiment, the at least one H₃O⁺ ion donor is a medium-strong acid having a pKₐ value from 0 to 2.5 at 20° C. If the pKₐ at 20° C. is 0 or less, the acid is preferably selected from sulphuric acid, hydrochloric acid, or mixtures thereof. If the pKₐ at 20° C. is from 0 to 2.5, the H₃O+ ion donor is preferably selected from H₂SO₃, H₃PO₄, oxalic acid, or mixtures thereof. The at least one H₃O⁺ ion donor can also be an acidic salt, for example, HSO₄⁻ or H₂PO₄⁻, being at least partially neutralized by a corresponding cation such as Li⁺, Na⁺ or K⁺, or HPO₄²⁻, being at least partially neutralised by a corresponding cation such as Li⁺, Na⁺, K⁺, Mg²⁺ or Ca²⁺. The at least one H₃O⁺ ion donor can also be a mixture of one or more acids and one or more acidic salts.

According to still another embodiment, the at least one H₃O⁺ ion donor is a weak acid having a pKₐ value of greater than 2.5 and less than or equal to 7, when measured at 20° C., associated with the ionisation of the first available hydrogen, and having a corresponding anion, which is capable of forming water-soluble calcium salts. Subsequently, at least one water-soluble salt, which in the case of a hydrogen-containing salt has a pKₐ of greater than 7, when measured at 20° C., associated with the ionisation of the first available hydrogen, and the salt anion of which is capable of forming water-insoluble calcium salts, is additionally provided. According to the preferred embodiment, the weak acid has a pKₐ value from greater than 2.5 to 5 at 20° C., and more preferably the weak acid is selected from the group consisting of acetic acid, formic acid, propanoic acid, and mixtures thereof. Exemplary cations of said water-soluble salt are selected from the group consisting of potassium, sodium, lithium and mixtures thereof. In a more preferred embodiment, said cation is sodium or potassium. Exemplary anions of said water-soluble salt are selected from the group consisting of phosphate, dihydrogen phosphate, monohydrogen phosphate, oxalate, silicate, mixtures thereof and hydrates thereof. In a more preferred embodiment, said anion is selected from the group consisting of phosphate, dihydrogen phosphate, monohydrogen phosphate, mixtures thereof and hydrates thereof. In a most preferred embodiment, said anion is selected from the group consisting of dihydrogen phosphate, monohydrogen phosphate, mixtures thereof and hydrates thereof. Water-soluble salt addition may be performed dropwise or in one step. In the case of drop wise addition, this addition preferably takes place within a time period of 10 minutes. It is more preferred to add said salt in one step.

According to one embodiment of the present invention, the at least one H₃O⁺ ion donor is selected from the group consisting of hydrochloric acid, sulphuric acid, sulphurous acid, phosphoric acid, citric acid, oxalic acid, acetic acid, formic acid, and mixtures thereof. Preferably the at least one H₃O⁺ ion donor is selected from the group consisting of hydrochloric acid, sulphuric acid, sulphurous acid, phosphoric acid, oxalic acid, H₂PO₄⁻, being at least partially neutralised by a corresponding cation such as Li⁺, Na⁺ or K⁺, HPO₄²⁻, being at least partially neutralised by a corresponding cation such as Li⁺, Na⁺, K⁺, Mg²⁺, or Ca²⁺ and mixtures thereof, more preferably the at least one acid is selected from the group consisting of hydrochloric acid, sulphuric acid, sulphurous acid, phosphoric acid, oxalic acid, or mixtures thereof, and most preferably, the at least one H₃O⁺ ion donor is phosphoric acid.

According to one preferred embodiment, the surface-reacted calcium carbonate is a reaction product of natural ground calcium carbonate with carbon dioxide and one or more H₃O⁺ ion donors, wherein the carbon dioxide is formed in situ by the H₃O⁺ ion donors treatment, and wherein the one or more H₃O⁺ donor is phosphoric acid. In one preferred embodiment, the surface-reacted calcium carbonate is a reaction product of natural ground calcium carbonate and phosphoric acid.

The one or more H₃O⁺ ion donor can be added to the suspension as a concentrated solution or a more diluted solution. Preferably, the molar ratio of the H₃O⁺ ion donor to the natural or precipitated calcium carbonate is from 0.01 to 4, more preferably from 0.02 to 2, even more preferably 0.05 to 1 and most preferably 0.1 to 0.58.

As an alternative, it is also possible to add the H₃O⁺ ion donor to the water before the natural or precipitated calcium carbonate is suspended.

In a next step, the natural or precipitated calcium carbonate is treated with carbon dioxide. If a strong acid such as sulphuric acid or hydrochloric acid is used for the H₃O⁺ ion donor treatment of the natural or precipitated calcium carbonate, the carbon dioxide is automatically formed. Alternatively or additionally, the carbon dioxide can be supplied from an external source.

H₃O⁺ ion donor treatment and treatment with carbon dioxide can be carried out simultaneously which is the case when a strong or medium-strong acid is used. It is also possible to carry out H₃O⁺ ion donor treatment first, e.g. with a medium strong acid having a pKₐ in the range of 0 to 2.5 at 20° C., wherein carbon dioxide is formed in situ, and thus, the carbon dioxide treatment will automatically be carried out simultaneously with the H₃O⁺ ion donor treatment, followed by the additional treatment with carbon dioxide supplied from an external source.

In a preferred embodiment, the H₃O⁺ ion donor treatment step and/or the carbon dioxide treatment step are repeated at least once, more preferably several times. According to one embodiment, the at least one H₃O⁺ ion donor is added over a time period of at least about 5 min, preferably at least about 10 min, typically from about 10 to about 20 min, more preferably about 30 min, even more preferably about 45 min, and sometimes about 1 h or more.

Subsequent to the H₃O⁺ ion donor treatment and carbon dioxide treatment, the pH of the aqueous suspension, measured at 20° C., naturally reaches a value of greater than 6.0, preferably greater than 6.5, more preferably greater than 7.0, even more preferably greater than 7.5, thereby preparing the surface-reacted natural or precipitated calcium carbonate as an aqueous suspension having a pH of greater than 6.0, preferably greater than 6.5, more preferably greater than 7.0, even more preferably greater than 7.5.

In a particular preferred embodiment the surface reacted calcium carbonate is a reaction product of natural ground calcium carbonate (GNCC) with carbon dioxide and phosphoric acid, wherein the carbon dioxide is formed in situ by the phosphoric acid treatment.

Further details about the preparation of the surface-reacted natural calcium carbonate are disclosed in WO 00/39222 A1, WO 2004/083316 A1, WO 2005/121257 A2, WO 2009/074492 A1, EP 2 264 108 A1, EP 2 264 109 A1 and US 2004/0020410 A1, the content of these references herewith being included in the present application.

Similarly, surface-reacted precipitated calcium carbonate is obtained. As can be taken in detail from WO 2009/074492 A1, surface-reacted precipitated calcium carbonate is obtained by contacting precipitated calcium carbonate with H₃O⁺ ions and with anions being solubilized in an aqueous medium and being capable of forming water-insoluble calcium salts, in an aqueous medium to form a slurry of surface-reacted precipitated calcium carbonate, wherein said surface-reacted precipitated calcium carbonate comprises an insoluble, at least partially crystalline calcium salt of said anion formed on the surface of at least part of the precipitated calcium carbonate.

Said solubilized calcium ions correspond to an excess of solubilized calcium ions relative to the solubilized calcium ions naturally generated on dissolution of precipitated calcium carbonate by H₃O⁺ ions, where said H₃O⁺ ions are provided solely in the form of a counterion to the anion, i.e. via the addition of the anion in the form of an acid or non-calcium acid salt, and in absence of any further calcium ion or calcium ion generating source.

Said excess solubilized calcium ions are preferably provided by the addition of a soluble neutral or acid calcium salt, or by the addition of an acid or a neutral or acid non-calcium salt which generates a soluble neutral or acid calcium salt in situ.

Said H₃O⁺ ions may be provided by the addition of an acid or an acid salt of said anion, or the addition of an acid or an acid salt which simultaneously serves to provide all or part of said excess solubilized calcium ions.

In a further preferred embodiment of the preparation of the surface-reacted natural or precipitated calcium carbonate, the natural or precipitated calcium carbonate is reacted with the one or more H₃O⁺ ion donors and/or the carbon dioxide in the presence of at least one compound selected from the group consisting of silicate, silica, aluminium hydroxide, earth alkali aluminate such as sodium or potassium aluminate, magnesium oxide, or mixtures thereof. Preferably, the at least one silicate is selected from an aluminium silicate, a calcium silicate, or an earth alkali metal silicate. These components can be added to an aqueous suspension comprising the natural or precipitated calcium carbonate before adding the one or more H₃O⁺ ion donors and/or carbon dioxide.

Alternatively, the silicate and/or silica and/or aluminium hydroxide and/or earth alkali aluminate and/or magnesium oxide component(s) can be added to the aqueous suspension of natural or precipitated calcium carbonate while the reaction of natural or precipitated calcium carbonate with the one or more H₃O⁺ ion donors and carbon dioxide has already started. Further details about the preparation of the surface-reacted natural or precipitated calcium carbonate in the presence of at least one silicate and/or silica and/or aluminium hydroxide and/or earth alkali aluminate component(s) are disclosed in WO 2004/083316 A1, the content of this reference herewith being included in the present application.

The surface-reacted calcium carbonate can be kept in suspension, optionally further stabilised by a dispersant. Conventional dispersants known to the skilled person can be used. A preferred dispersant is comprised of polyacrylic acids and/or carboxymethylcelluloses.

Alternatively, the aqueous suspension described above can be dried, thereby obtaining the solid (i.e. dry or containing as little water that it is not in a fluid form) surface-reacted natural or precipitated calcium carbonate in the form of granules or a powder.

In a preferred embodiment, the surface-reacted calcium carbonate has a specific surface area of from 15 m²/g to 200 m²/g, preferably from 27 m²/g to 180 m²/g, more preferably from 30 m²/g to 160 m²/g, even more preferably from 45 m²/g to 150 m²/g, most preferably from 48 m²/g to 140 m²/g, measured using nitrogen and the BET method. For example, the surface-reacted calcium carbonate has a specific surface area of from 75 m²/g to 100 m²/g, measured using nitrogen and the BET method. The BET specific surface area in the meaning of the present invention is defined as the surface area of the particles divided by the mass of the particles. As used therein the specific surface area is measured by adsorption using the BET isotherm (ISO 9277:2010) and is specified in m²/g.

It is furthermore preferred that the surface-reacted calcium carbonate particles have a volume median grain diameter d₅₀ (vol) of from 1 to 75 μm, preferably from 2 to 50 μm, more preferably 3 to 40 μm, even more preferably from 4 to 30 μm, and most preferably from 5 to 15 μm.

It may furthermore be preferred that the surface-reacted calcium carbonate particles have a grain diameter d₉₈ (vol) of from 2 to 150 μm, preferably from 4 to 100 μm, more preferably 6 to 80 μm, even more preferably from 8 to 60 μm, and most preferably from 10 to 30 μm.

The value dₓ represents the diameter relative to which x % of the particles have diameters less than dₓ. This means that the d₉₈ value is the particle size at which 98% of all particles are smaller. The d₉₈ value is also designated as “top cut”. The dₓ values may be given in volume or weight percent. The d₅₀ (wt) value is thus the weight median particle size, i.e. 50 wt.-% of all grains are smaller than this particle size, and the d₅₀ (vol) value is the volume median particle size, i.e. 50 vol.-% of all grains are smaller than this particle size.

Volume median grain diameter d₅₀ can be evaluated using a Malvern Mastersizer 2000 Laser Diffraction System. The d₅₀ or d₉₈ value, measured using a Malvern Mastersizer 2000 Laser Diffraction System, indicates a diameter value such that 50% or 98% by volume, respectively, of the particles have a diameter of less than this value. The raw data obtained by the measurement are analysed using the Mie theory, with a particle refractive index of 1.57 and an absorption index of 0.005.

The processes and instruments are known to the skilled person and are commonly used to determine grain size of fillers and pigments.

The specific pore volume is measured using a mercury intrusion porosimetry measurement using a Micromeritics Autopore V 9620 mercury porosimeter having a maximum applied pressure of mercury 414 MPa (60 000 psi), equivalent to a Laplace throat diameter of 0.004 μm (˜ nm). The equilibration time used at each pressure step is 20 seconds. The sample material is sealed in a 5 cm³ chamber powder penetrometer for analysis. The data are corrected for mercury compression, penetrometer expansion and sample material compression using the software Pore-Comp (Gane, P. A. C., Kettle, J. P., Matthews, G. P. and Ridgway, C. J., “Void Space Structure of Compressible Polymer Spheres and Consolidated Calcium Carbonate Paper-Coating Formulations”, Industrial and Engineering Chemistry Research, 35(5), 1996, p1753-1764).

The total pore volume seen in the cumulative intrusion data can be separated into two regions with the intrusion data from 214 μm down to about 1-4 μm showing the coarse packing of the sample between any agglomerate structures contributing strongly. Below these diameters lies the fine interparticle packing of the particles themselves. If they also have intraparticle pores, then this region appears bi modal, and by taking the specific pore volume intruded by mercury into pores finer than the modal turning point, i.e. finer than the bi-modal point of inflection, the specific intraparticle pore volume is defined. The sum of these three regions gives the total overall pore volume of the powder, but depends strongly on the original sample compaction/settling of the powder at the coarse pore end of the distribution.

By taking the first derivative of the cumulative intrusion curve the pore size distributions based on equivalent Laplace diameter, inevitably including pore-shielding, are revealed. The differential curves clearly show the coarse agglomerate pore structure region, the interparticle pore region and the intraparticle pore region, if present. Knowing the intraparticle pore diameter range it is possible to subtract the remainder interparticle and interagglomerate pore volume from the total pore volume to deliver the desired pore volume of the internal pores alone in terms of the pore volume per unit mass (specific pore volume). The same principle of subtraction, of course, applies for isolating any of the other pore size regions of interest.

Preferably, the surface-reacted calcium carbonate has an intra-particle intruded specific pore volume in the range from 0.1 to 2.3 cm³/g, more preferably from 0.2 to 2.0 cm³/g, especially preferably from 0.4 to 1.8 cm³/g and most preferably from 0.6 to 1.6 cm³/g, calculated from mercury porosimetry measurement.

The intra-particle pore size of the surface-reacted calcium carbonate preferably is in a range of from 0.004 to 1.6 μm, more preferably in a range of from 0.005 to 1.3 μm, especially preferably from 0.006 to 1.15 μm and most preferably of 0.007 to 1.0 μm, determined by mercury porosimetry measurement.

### Wax (Optional)

The aqueous coating composition optionally comprises a wax.

The way may be selected from the group consisting of plant waxes (e.g. carnauba wax, jojoba oil, candelilla wax, ouricury wax), animal waxes (e.g. wool wax, beeswax, china wax), hydrocarbon waxes, and mixtures thereof.

Preferably, the wax is a hydrocarbon wax, and most preferably the wax is a paraffin wax or a polyolefin wax (e.g. polyethylene wax).

Most preferably, the way is a paraffin wax. A “paraffin wax” in the meaning of the present invention is a compound derived from petroleum, coal or shale oil, which consists of a mixture of hydrocarbons, preferably hydrocarbons containing from 20 to 40 carbon atoms, and which is solid at 25° C. and begins to melt at a temperature in the range of 40 to 90° C., preferably 60 to 80° C. A suitable paraffin wax is the paraffin wax with the CAS no. 8002-74-2.

Wax can be present in the aqueous coating composition in a weight amount of 0.1 to 15 wt. %, preferably 1 to 15 wt. %, more preferably 1 to 11 wt. % (e.g. 3 to 11 wt. %, 5 to 11 wt. %, or 7 to 11 wt. %), based on the total dry weight of the coating composition.

### Additives (Optional)

The aqueous coating composition according to the invention optionally comprises one or more additives selected from the group of acids, bases, rheology modifiers, viscosity enhancers, antifoaming agents, biocides, tension surface modifiers and dispersing agents.

The one or more additives can be present in the aqueous coating composition in a weight amount of 0.01 to 5.0 wt. %, preferably 0.01 to 4.0 wt. % (e.g. 0.1 to 4.0 wt. %), based on the total dry weight of the composition.

The list of additives provided herein is not exhaustive. A skilled person can select and add further additives if necessary.

### Coating Composition

The present invention relates in one aspect to an aqueous coating composition comprising
(a) a polymer A comprising units derived from an alpha-olefin and one or more comonomers selected from the group of methacrylates, acrylates, methacrylic acid, acrylic acid, maleates, maleic acid, maleic anhydride, and salts thereof;
(b) a polymer B comprising units derived from one or more monomers selected from the group of methacrylates, acrylates, methacrylic acid, acrylic acid, maleates, maleic acid, maleic anhydride, and salts thereof;
(c) at least one pigment in an amount in the range of 0.1 to 30 wt. %, based on the total dry weight of the coating composition, wherein the at least one pigment is selected from the group consisting of clay minerals, silicates, brucite, magnesium carbonate, barite, perlite, satin white, gypsum, aluminum oxide, titanium dioxide, surface-reacted calcium carbonates, and mixtures thereof; and
(d) optionally a wax.

For preferred embodiments of polymer A, polymer B, the at least one pigment, optional wax and optional additives, it is referred to the sections above.

The coating composition of the invention comprises water. In addition to water, the aqueous coating composition can comprise one or more other fluid media such as organic solvents. However, it is preferred that the coating composition only contains water as liquid medium.

The aqueous coating composition typically comprises polymer A and polymer B in a specific weight ratio with respect to each other. According to one preferred embodiment of the present invention, the aqueous coating composition comprises polymer A and polymer B in a weight ratio in the range of 50:50 to 99:1 (e.g. >50:<50 to 99:1), preferably >65:<35 to 99:1 (e.g. 70:30 to 99:1 or 75:25 to 95:5).

Further, the aqueous coating composition typically comprises a specific combined amount of polymer A and polymer B in the coating composition. According to one preferred embodiment of the present invention, the aqueous coating composition comprises 60 to 99.9 wt. %, preferably 75 to 99.9 wt. % (e.g. 85 to 95 wt. % or 90 to 95 wt. %), of a combined amount of polymers A and B, based on the total dry weight of the coating composition.

The aqueous coating composition typically comprises the mandatory and optional components in specific weight amounts, based on the total dry weight of the coating composition. A person of skill will have no difficulty of selecting the specific weight amounts of the mandatory and optional components in such a way that they add up to 100 wt. %. Preferably the indicated weight amounts of the mandatory and optional components are selected to add up to 100 wt. %.

According to one preferred embodiment of the invention, the aqueous coating composition comprises, based on the total weight of the coating composition:
(a) 55 to 98 wt. %, preferably 60 to 85 wt. % (e.g. 60 to 80 wt. % or 60 to 70 wt. %), of polymer A,
(b) 1 to 30 wt. %, preferably 5 to 25 wt. % (e.g. 10 to 25 wt. % or 15 to 25 wt. %), of polymer B,
(c) 0.1 to 30 wt. %, preferably 0.1 to <20 wt. % (e.g. 1 to 15 wt. %, 2 to 15 wt. %, 2 to 12.5 wt. %, 2 to 10 wt. % or 2 to 8 wt. %), of the at least one pigment, and
(d) optionally 0.1 to 15 wt. %, preferably 1 to 11 wt. % (e.g. 7 to 11 wt. %), of wax.

According to one preferred embodiment of the invention, the aqueous coating composition comprises, based on the total weight of the coating composition:
(a) 55 to 98 wt. %, preferably 60 to 85 wt. % (e.g. 60 to 80 wt. % or 60 to 70 wt. %), of polymer A,
(b) 1 to 30 wt. %, preferably 5 to 25 wt. % (e.g. 10 to 25 wt. % or 15 to 25 wt. %), of polymer B,
(c) 0.1 to 30 wt. %, preferably 0.1 to <20 wt. % (e.g. 1 to 15 wt. %, 2 to 15 wt. %, 2 to 12.5 wt. %, 2 to 10 wt. % or 2 to 8 wt. %), of the at least one pigment, and
(d) 0.1 to 15 wt. %, preferably 1 to 11 wt. % (e.g. 7 to 11 wt. %), of wax.

According to one preferred embodiment of the invention, the aqueous coating composition comprises, based on the total weight of the coating composition:
(a) 55 to 98 wt. %, preferably 60 to 85 wt. % (e.g. 60 to 80 wt. % or 60 to 70 wt. %), of polymer A,
(b) 1 to 30 wt. %, preferably 5 to 25 wt. % (e.g. 10 to 25 wt. % or 15 to 25 wt. %), of polymer B,
(c) 0.1 to 30 wt. %, preferably 0.1 to <20 wt. % (e.g. 1 to 15 wt. %, 2 to 15 wt. %, 2 to 12.5 wt. %, 2 to 10 wt. % or 2 to 8 wt. %), of the at least one pigment, and
(d) 0.1 to 15 wt. %, preferably 1 to 11 wt. % (e.g. 7 to 11 wt. %), of wax.
(e) optionally 0.01 to 5.0 wt. %, preferably 0.01 to 4.0 wt. % (e.g. 0.1 to 4.0 wt. %), of additives.

According to one preferred embodiment of the invention, the aqueous coating composition comprises, based on the total weight of the coating composition:
(a) 55 to 98 wt. %, preferably 60 to 85 wt. % (e.g. 60 to 80 wt. % or 60 to 70 wt. %), of polymer A,
(b) 1 to 30 wt. %, preferably 5 to 25 wt. % (e.g. 10 to 25 wt. % or 15 to 25 wt. %), of polymer B,
(c) 0.1 to 30 wt. %, preferably 0.1 to <20 wt. % (e.g. 1 to 15 wt. %, 2 to 15 wt. %, 2 to 12.5 wt. %, 2 to 10 wt. % or 2 to 8 wt. %), of the at least one pigment, and
(d) 0.1 to 15 wt. %, preferably 1 to 11 wt. % (e.g. 7 to 11 wt. %), of wax.
(e) 0.01 to 5.0 wt. %, preferably 0.01 to 4.0 wt. % (e.g. 0.1 to 4.0 wt. %), of additives.

The aqueous coating composition typically comprises the mandatory and optional components in specific weight amounts relative to each other (dry parts per weight).

According to one embodiment of the invention, the aqueous coating composition comprises:
(a) 50 to 99, preferably >65 to 95 (e.g. 70 to 95), parts per weight of polymer A,
(b) 1 to 50, preferably 5 to <35 (e.g. 5 to 25), parts per weight of polymer B,
(c) 1 to 30, preferably 1 to <20 (e.g. 1 to 15), parts per weight of the at least one pigment, and
(d) optionally 1 to 15, preferably 5 to 12 (e.g. 7 to 12), parts per weight of wax.

According to one embodiment of the invention, the aqueous coating composition comprises:
(a) 50 to 99, preferably >65 to 95 (e.g. 70 to 95), parts per weight of polymer A,
(b) 1 to 50, preferably 5 to <35 (e.g. 5 to 25), parts per weight of polymer B,
(c) 1 to 30, preferably 1 to <20 (e.g. 1 to 15), parts per weight of the at least one pigment, and
(d) 1 to 15, preferably 5 to 12 (e.g. 7 to 12), parts per weight of wax.

According to one embodiment of the invention, the aqueous coating composition comprises:
(a) 50 to 99, preferably >65 to 95 (e.g. 70 to 95), parts per weight of polymer A,
(b) 1 to 50, preferably 5 to <35 (e.g. 5 to 25), parts per weight of polymer B,
(c) 1 to 30, preferably 1 to <20 (e.g. 1 to 15), parts per weight of the at least one pigment, and
(d) 1 to 15, preferably 5 to 12 (e.g. 7 to 12), parts per weight of wax.
(e) optionally 0.01 to 7.5, preferably 0.1 to 5, parts per weight of additives.

According to one embodiment of the invention, the aqueous coating composition comprises:
(a) 50 to 99, preferably >65 to 95 (e.g. 70 to 95), parts per weight of polymer A,
(b) 1 to 50, preferably 5 to <35 (e.g. 5 to 25), parts per weight of polymer B,
(c) 1 to 30, preferably 1 to <20 (e.g. 1 to 15), parts per weight of the at least one pigment, and
(d) 1 to 15, preferably 5 to 12 (e.g. 7 to 12), parts per weight of wax.
(e) 0.01 to 7.5, preferably 0.1 to 5, parts per weight of additives.

The aqueous coating composition according to the invention may have a specific solids content, pH value, and/or viscosity.

According to one embodiment, the aqueous coating composition has a solids content in the range of 5 to 70 wt. %, preferably of 20 to 60 wt. % (e.g. 30 to 50 wt. %).

According to one embodiment, the aqueous coating composition has a pH value in the range of 7.5 to 12, preferably 8 to 11 (e.g. 8 to 9.5 or 8.0 to 9.0).

The aqueous coating composition can have a viscosity (at 100 rpm) in the range to 25 to 2000 mPa*s according to ISO 1652:2011. The viscosity can depend on the amount of the at least one pigment being present in the composition.

According to one embodiment, the aqueous coating composition has a solids content in the range of 5 to 70 wt. %, preferably of 20 to 60 wt. %, and more preferably 30 to 50 wt. %, and a pH value in the range of 7.5 to 12, and preferably 8 to 11.

According to a preferred embodiment, the aqueous coating composition comprises a dispersing agent as an additive. The dispersing agent may be used to disperse the at least one pigment in the composition.

The aqueous coating composition as defined herein is obtainable or can be obtained by a process comprising the steps of:
providing an aqueous composition I, preferably an aqueous dispersion, comprising polymer A and preferably a wax,
providing an aqueous composition II, preferably an aqueous dispersion, comprising polymer B and preferably a wax,
providing the at least one pigment,
mixing the aqueous composition I and II and the at least one pigment.

The mixing step can be carried out in any order. It is however preferred that the aqueous compositions I and II comprising polymer A and B are mixed first, followed by addition of the at least one pigment.

In one preferred embodiment, aqueous composition I is an aqueous dispersion comprising polymer A and a wax in a weight ratio of 98:2 to 80:20, preferably 95:5 to 85:15 (e.g. about 90:10), wherein the dispersion has a solids content of 30 to 60 wt. %, preferably 35 to 50 wt. % (e.g. about 39.5 wt. %).

In one preferred embodiment, aqueous composition II is an aqueous dispersion comprising polymer B and a wax in a weight ratio of 98:2 to 80:20, preferably 95:5 to 85:15 (e.g. about 90:10), wherein the dispersion has a solids content of 30 to 60 wt. %, preferably 45 to 55 wt. % (e.g. about 50.5 wt. %).

The at least one pigment may be provided in solid or in liquid form. “Solid form” means for the present invention that the pigment is not combined with a liquid media. The at least one pigment may be provided in liquid form, e.g. as an aqueous composition or an aqueous slurry. Hence, the aqueous coating composition as defined herein is obtainable or can be obtained by a process comprising the steps of:
providing an aqueous composition I, preferably an aqueous dispersion, comprising polymer A and preferably a wax,
providing an aqueous composition II, preferably an aqueous dispersion, comprising polymer B and preferably a wax,
providing an aqueous composition Ill comprising the at least one pigment,
mixing the aqueous composition I to Ill in any order, and preferably mixing the aqueous composition I and II, followed by adding the aqueous composition III.

Additives may be added to any one of aqueous compositions I to III and/or to the composition obtained by mixing aqueous compositions I to III.

In one embodiment, the at least one pigment is provided in form of an aqueous composition III, which is an aqueous suspension comprising the at least one pigment, wherein the suspension has a solids content in the range of 1 to 85 wt. % preferably 50 to 85 wt. %. The at least one pigment may be dispersed by a dispersing agent.

According to one embodiment, the aqueous coating composition is obtainable or obtained by a process comprising the steps of:
providing an aqueous composition I which is: an aqueous dispersion comprising polymer A and a wax in a weight ratio of 98:2 to 80:20, preferably 95:5 to 85:15 (e.g. about 90:10), wherein the dispersion has a solids content of 30 to 60 wt. %, preferably 35 to 50 wt. % (e.g. about 39.5 wt. %),
providing an aqueous composition II which is: aqueous dispersion comprising polymer B and a wax in a weight ratio of 98:2 to 80:20, preferably 95:5 to 85:15 (e.g. about 90:10), wherein the dispersion has a solids content of 30 to 60 wt. %, preferably 45 to 55 wt. % (e.g. about 50.5 wt. %),
providing an aqueous composition III which is: an aqueous suspension comprising the at least one pigment, wherein the suspension has a solids content in the range of 1 to 85 wt. % preferably 50 to 85 wt. %,
mixing the aqueous compositions I and II, followed by the addition of the aqueous composition III, optionally followed by one or more steps selected from adjusting the pH value, adjusting the viscosity and adding additives.

Additives may be added to any one of aqueous compositions I to III and/or to the composition obtained by mixing aqueous compositions I to III.

According to another embodiment, the aqueous coating composition is obtainable or obtained by a process comprising the steps of:
providing an aqueous composition I which is: an aqueous dispersion comprising polymer A and a wax in a weight ratio of 98:2 to 80:20, preferably 95:5 to 85:15 (e.g. about 90:10), wherein the dispersion has a solids content of 30 to 60 wt. %, preferably 35 to 50 wt. % (e.g. about 39.5 wt. %),
providing an aqueous composition II which is: aqueous dispersion comprising polymer B and a wax in a weight ratio of 98:2 to 80:20, preferably 95:5 to 85:15 (e.g. about 90:10), wherein the dispersion has a solids content of 30 to 60 wt. %, preferably 45 to 55 wt. % (e.g. about 50.5 wt. %),
providing the at least one pigment in solid form,
mixing the aqueous compositions I and II, followed by the addition of the at least one pigment,
optionally followed by one or more steps selected from adjusting the pH value, adjusting the viscosity and adding additives.

### Process for Preparing the Coating Composition

Another aspect of the present invention relates to a process for preparing an aqueous coating composition according to the invention. The process comprises the steps of:
providing an aqueous composition I comprising polymer A as defined herein and optionally a wax as defined herein,
providing an aqueous composition II comprising polymer B as defined herein and optionally a wax as defined herein,
providing at least one pigment as defined herein, mixing the aqueous compositions I and II and the at least one pigment.

The skilled person can select conditions or equipment for mixing the aqueous compositions I to III (and optional additives) according to her or his needs. Regarding preferred embodiments of polymer A, polymer B, the at least one pigment, optional wax and optional additives, it is referred to the above sections. Additives as defined herein can be added to any one of aqueous compositions I to III and/or to the composition obtained by mixing the aqueous compositions I to III.

The mixing step can be carried out in any order. It is however preferred that the aqueous compositions I and II comprising polymer A and B are mixed first, followed by addition of the at least one pigment.

In one preferred embodiment, aqueous composition I is an aqueous dispersion comprising polymer A and the wax in a weight ratio of 98:2 to 80:20, preferably 95:5 to 85:15 (e.g. about 90:10), wherein the dispersion has a solids content of 30 to 60 wt. %, preferably 35 to 50 wt. % (e.g. about 39.5 wt. %).

In one preferred embodiment, aqueous composition II is an aqueous dispersion comprising polymer B and the wax in a weight ratio of 98:2 to 80:20, preferably 95:5 to 85:15 (e.g. about 90:10), wherein the dispersion has a solids content of 30 to 60 wt. %, preferably 45 to 55 wt. % (e.g. about 50.5 wt. %).

The at least one pigment may be provided in solid or in liquid form. The at least one pigment may be provided in liquid form, more preferably as an aqueous composition, and even more preferably in form of a slurry. Slurries of the at least one pigment as defined herein are known. Preferably, the at least one pigment is dispersed in the slurry by a dispersing agent.

The process according to the invention can comprise the steps of:
providing an aqueous composition I, preferably an aqueous dispersion, comprising polymer A and preferably the wax,
providing an aqueous composition II, preferably an aqueous dispersion, comprising polymer B and preferably the wax,
providing an aqueous composition III comprising the at least one pigment,
mixing the aqueous composition I to Ill in any order, and preferably mixing the aqueous composition I and II, followed by adding the aqueous composition III.

Alternatively, the process according to the invention can comprise the steps of:
providing an aqueous composition I, preferably an aqueous dispersion, comprising polymer A and preferably the wax,
providing an aqueous composition II, preferably an aqueous dispersion, comprising polymer B and preferably the wax,
providing the at least one pigment in solid form,
mixing the aqueous composition I and II and the at least one pigment in any order, and preferably mixing the aqueous composition I and II, followed by adding the pigment.

In one embodiment, the at least one pigment is provided in form of an aqueous composition III, which is an aqueous suspension comprising the at least one pigment, wherein the suspension has a solids content in the range of 1 to 85 wt. % preferably 50 to 85 wt. %. Preferably, the at least one pigment is dispersed by a dispersing agent.

According to one embodiment, the process comprises the steps of:
providing an aqueous composition I which is: an aqueous dispersion comprising polymer A and the wax in a weight ratio of 98:2 to 80:20, preferably 95:5 to 85:15 (e.g. about 90:10), wherein the dispersion has a solids content of 30 to 60 wt. %, preferably 35 to 50 wt. % (e.g. about 39.5 wt. %),
providing an aqueous composition II which is: aqueous dispersion comprising polymer B and the wax in a weight ratio of 98:2 to 80:20, preferably 95:5 to 85:15 (e.g. about 90:10), wherein the dispersion has a solids content of 30 to 60 wt. %, preferably 45 to 55 wt. % (e.g. about 50.5 wt. %),
providing an aqueous composition III which is: an aqueous suspension comprising the at least one pigment, wherein the suspension has a solids content in the range of 1 to 85 wt. % preferably 50 to 85 wt. %,
mixing the aqueous compositions I and II, followed by the addition of the aqueous composition III,
optionally followed by one or more steps selected from adjusting the pH value, adjusting the viscosity and adding additives.

Additives may be added to any one of aqueous compositions I to Ill and/or to the composition obtained by mixing aqueous compositions I to III.

According to another embodiment, the process comprises the steps of:
providing an aqueous composition I which is: an aqueous dispersion comprising polymer A and the wax in a weight ratio of 98:2 to 80:20, preferably 95:5 to 85:15 (e.g. about 90:10), wherein the dispersion has a solids content of 30 to 60 wt. %, preferably 35 to 50 wt. % (e.g. about 39.5 wt. %),
providing an aqueous composition II which is: aqueous dispersion comprising polymer B and the wax in a weight ratio of 98:2 to 80:20, preferably 95:5 to 85:15 (e.g. about 90:10), wherein the dispersion has a solids content of 30 to 60 wt. %, preferably 45 to 55 wt. % (e.g. about 50.5 wt. %),
providing at least one pigment in solid form,
mixing the aqueous compositions I and II, followed by the addition of the at least one pigment,
optionally followed by one or more steps selected from adjusting the pH value, adjusting the viscosity and adding additives.

### Coated Article

In another aspect, the invention refers to a coated article comprising a substrate, wherein at least one surface of the substrate comprises a coating prepared from an aqueous coating composition according to the invention.

A skilled person knows how to prepare a coating from the aqueous coating composition according to the invention. The coating may be prepared by coating at least one surface of the substrate with the aqueous coating composition, and drying the aqueous coating composition or allowing the aqueous coating composition to dry.

The coating step can be carried out by rod coating, blade coating, curtain coating or by printing techniques such as flexographic printing or offset printing. Such methods are known in the art. Rod coating as one preferred way of coating is also described in the examples.

The drying step can be carried out by hot air, air jet and/or IR drying. Such methods are also known in the art.

The substrate is not particularly limited. The substrate may be a plastic, which is suitable for use in the packaging sector such as but not limited to polyolefins (e.g. PE, PP, polystyrene), polyesters (e.g. PET, PLA), and mixtures thereof. The substrate may be a metal such as aluminum (e.g. aluminum foil). According to one embodiment, the substrate is a plastic (preferably a polyolefin, a polyester, a polystyrene, or mixtures thereof), a metal (preferably aluminum) or a cellulose-based substrate. It is preferred that the substrate is a cellulose-based substrate. Suitable cellulose-based substrates are, for example, fine paper, paper, recycled paper, paperboard, corrugated paperboard, card stock, wall paper, photo paper or tissue paper. The cellulose-based substrate is not limited to a specific shape or form. The cellulose-based substrate may be die cutted and/or cut to a specific geometrical form etc.

According to one preferred embodiment of the invention, the substrate is a cellulose-based substrate, preferably a paper, a paper board, or a card board.

The cellulose-based substrate, preferably the paper, paper board, or card board, can have a grammage in the range of from 15 to 500 g/m², more preferably from 50 to 400 g/m², and most preferably 100 to 350 g/m².

The coated article can comprise a pre-coating between the at least one surface of the substrate, preferably cellulose-based substrate, more preferably the paper, paper board, or card board, and the coating. The pre-coating may be calendared. The pre-coating can comprise at least one mineral and a binder (e.g. a latex).

The at least one mineral may be selected from the group consisting of kaolin, clay, dolomite, mica, calcium carbonate, talc, and mixtures thereof. According to one embodiment, the pre-coating comprises calcium carbonate. It is possible, sometimes preferred, that calcium carbonate is the only mineral in the pre-coating. Thus, in one embodiment, the pre-coating comprises one mineral which is calcium carbonate. It is however also possible to use, for example, a mineral mixture comprising a calcium carbonate and at least one further mineral. For example, a mineral mixture of calcium carbonate and talc may be used for the pre-coating composition. For example, the mineral mixture may be calcium carbonate and talc in a weight ratio of 60:40 to 20:80, preferably 60:40 to 40:60 (e.g. about 50:50).

The pre-coating can comprise
20 to 60, preferably 40 to 60 (e.g. about 50), parts by weight of calcium carbonate,
40 to 80, preferably 40 to 60 (e.g. about 50), parts by weight of talc,
2 to 20, preferably 5 to 15 (e.g. about 10), parts by weight of a binder (e.g. a latex),
and 0.01 to 1 parts by weight of additive, preferably rheology modifier.

The pre-coating may have a coating weight of 1 to 20 g/m², preferably 2 to 15 g/m², more preferably 3 to 12 g/m².

According to one embodiment, the coated article comprises the coating prepared from the aqueous coating composition according to the invention on the at least one surface of the substrate in an amount of 1 to 20 g/m², preferably from 2 to 15 g/m², more preferably from 5 to 15 g/m², and most preferably from 5 to 13 g/m².

It has been found that the aqueous coating composition or its dried form can be used in a comparatively low weight amount while still providing very good results in terms of barrier properties, sealability, etc. Besides needing less resources for its production, the low amount of heat-sealable coating is particularly advantageous for recycling the coated article at a later stage.

Another aspect of the present invention relates to a process for preparing a coated article according to the invention. The process preferably comprises the steps of
providing a substrate having at least one surface,
providing an aqueous coating composition as defined herein,
coating at least one surface of the substrate with the aqueous coating composition,
drying the aqueous coating composition or allowing the aqueous coating composition to dry.

The coating step can be carried out by rod coating, blade coating, curtain coating or by printing techniques such as flexographic printing, rotogravure or offset printing. Such methods are known in the art.

The drying step can be carried out by hot air, air jet and/or IR drying. Such methods are known in the art.

Further embodiments disclosed herein are defined by the following clauses:
[1] An aqueous coating composition comprising
(a) a polymer A comprising units derived from an alpha-olefin and one or more comonomers selected from the group of methacrylates, acrylates, methacrylic acid, acrylic acid, maleates, maleic acid, maleic anhydride, and salts thereof;
(b) a polymer B comprising units derived from one or more monomers selected from the group of methacrylates, acrylates, methacrylic acid, acrylic acid, maleates, maleic acid, maleic anhydride, and salts thereof;
(c) at least one pigment in an amount in the range of 0.1 to 30 wt. %, based on the total dry weight of the coating composition, wherein the at least one pigment is selected from the group consisting of clay minerals, silicates, brucite, magnesium carbonate, barite, perlite, satin white, gypsum, aluminum oxide, titanium dioxide, surface-reacted calcium carbonates, and mixtures thereof; and
(d) optionally a wax.
[2] The aqueous coating composition according to [1], wherein the at least one pigment is at least one pigment selected from the group of phyllosilicates, preferably from the group consisting of talc, kaolin, mica, montmorillonite, and combinations thereof, or
wherein the at least one pigment is at least one surface-reacted calcium carbonate.
[3] The aqueous coating composition according to [1] or [2], wherein the aqueous coating composition comprises polymer A and polymer B in a weight ratio of 50:50 to 99:1, and preferably >65:<35 to 99:1.
[4] The aqueous coating composition according to any one of [1] to [3], wherein the aqueous coating composition comprises 60 to 99.9 wt. %, preferably 75 to 99.9 wt. %, of a combined amount of polymers A and B, based on the total dry weight of the coating composition.
[5] The aqueous coating composition according to any one of [1] to [4], wherein the aqueous coating composition comprises the at least one pigment in an amount of 0.1 to below 20 wt. %, preferably of 0.1 to 12.5 wt. %, based on the total dry weight of the coating composition.
[6] The aqueous coating composition according to any one of [1] to [5], wherein the aqueous coating composition comprises:
(a) 50 to 99, preferably >65 to 95, parts per weight of polymer A,
(b) 1 to 50, preferably 5 to <35, parts per weight of polymer B,
(c) 1 to 30, preferably 1 to <20, parts per weight of the at least one pigment, and
(d) optionally 1 to 15, preferably 5 to 12, parts per weight of wax.
[7] The aqueous coating composition according to any one of [1] to [6], wherein
the polymer A comprises, preferably consists of, units derived from an alpha-olefin, preferably ethylene, and one or more monomers selected from the group of methacrylates, acrylates, methacrylic acid, acrylic acid, and salts thereof, and/or
the polymer B comprises, preferably consists of, units derived from one or more, preferably two to four, monomers selected from the group of methacrylates, acrylates, methacrylic acid, acrylic acid, and salts thereof.
[8] The aqueous coating composition according to any one of [1] to [7], wherein the polymer A is a copolymer of ethylene and acrylic acid, and/or the polymer B is a polymer of acrylic acid and from one to three C₁-C₆ alkyl acrylate and/or C₁-C₆ alkyl methacrylate monomers.
[9] The aqueous coating composition according to any one of [1] to [8], wherein polymer A has a comonomer content, preferably an acrylic acid content, in the range from 0.5 to 25 mol-%, preferably from 15 to 25 mol-%,
or polymer A has a comonomer content, preferably an acrylic acid content, in the range from 5 to 30 wt. %, preferably from 10 to 25 wt. %.
[10] The aqueous coating composition according to any one of [1] to [9], wherein the wax is a hydrocarbon wax, preferably a paraffin wax.
[11] The aqueous coating composition according to any one of [1] to [10], wherein
the aqueous coating composition has a solids content in the range of 5 to 70 wt. %, and preferably of 20 to 60 wt. %, and/or
the aqueous coating composition has a pH value in the range of 7.5 to 12, and preferably 8 to 11.
[12] A process for preparing the aqueous coating composition according to any of [1] to [11], comprising the steps of:
providing an aqueous composition I comprising polymer A and optionally a wax,
providing an aqueous composition II comprising polymer B and optionally a wax,
providing the at least one pigment,
mixing the aqueous compositions I and II and the at least one pigment.
[13] A coated article comprising a substrate, wherein at least one surface of the substrate comprises a coating prepared from an aqueous coating composition according to any one of [1] to [11].
[14] The coated article according to [13], wherein the substrate is a cellulose-based substrate, a plastic or a metal, preferably a cellulose-based substrate, and more preferably a paper, a paper board, or a card board.
[15] The coated article according to or [14], wherein the coated article comprises a pre-coating between the at least one surface of the substrate and the coating,
wherein the pre-coating comprises at least one mineral and a binder.

In the following, the present invention will be described by specific exemplary embodiments. The following embodiments shall not be construed as limiting the present invention in any way.

### EXAMPLES

### 1. Methods and Instruments

### Particle Size Distribution

Weight-median particle size d₅₀ and weight top cut particle size d₉₈ values was measured using a Sedigraph 5120 from the company Micromeritics Instrument Corporation, USA. The method and the instrument are known to the skilled person and are commonly used to determine grain size of fillers and pigments. The measurements can be carried out in an aqueous solution comprising 0.1 wt.-% Na₄P₂O₇. The samples may be dispersed using a high speed stirrer and supersonics.

Volume-median particle size d₅₀(vol) and volume top cut particle size d₉₈(vol) is measured as follows:

Volume median particle size d₅₀ was measured using a Malvern Mastersizer 2000 or 3000 Laser Diffraction System. The d₅₀ or d₉₈ value, measured using a Malvern Mastersizer 2000 or 3000 Laser Diffraction System, indicates a diameter value such that 50% or 98% by volume, respectively, of the particles have a diameter of less than this value. The raw data obtained by the measurement are analysed using the Mie theory, with a particle refractive index of 1.57 and an absorption index of 0.005. The measurements can be carried out in an aqueous solution comprising 0.1 wt.-% Na₄P₂O₇. The samples may be dispersed using a high speed stirrer and supersonics.

Alternatively, the sample can be measured in dry condition without any prior treatment.

### Solids Content of Aqueous Coating Composition

The suspension solids content (also known as “dry weight”) was determined using a Moisture Analyser MJ33 from the company Mettler-Toledo, Switzerland, with the following settings: drying temperature of 160° C., automatic switch off if the mass does not change more than 1 mg over a period of 30 s, standard drying of 5 to 20 g of suspension.

### Determination of Water Absorptiveness

Cobb Unger (wl5) was measured using ISO 535:1991(E). In accordance with this method, the mass of water absorbed in a specified time by g/m² of paper or board during 1800 s time under specified conditions is measured. The conditioning atmosphere is according to ISO 187 (23° C./50% RH). For the measurement of hot water absorptiveness, in accordance with this method, the mass of water at 90° C. absorbed in a specified time by g/m² of paper or board during 60 s time under specified conditions is measured.

### Preparation of Aqueous Coating Compositions

The mixing steps of the process described herein was done with a Pendraulik Laboratory Dissolver, model LD 50.

### Coating of Paper Substrates

The coatings were applied at a coating speed of 20 m/min using a Durrer continuous laboratory coater (Switzerland) using rod metering (X23 (23 mL/m², rod pressure of approximately 1 bar, rod revolutions of 12 rpm). Pre-coatings were applied with the same machine but with a blade aggregate: 20 m/min, blade thickness 0.3 mm and blade pressure 1 bar. Coatings and pre-coatings were dried by infrared drying and air drying.

### Hot Air Sealing

Measurement for hot air sealability was performed between temperature from 300 to 500° C. with sample size of 105 mm MD×155 mm CD (sealed area 105 mm×3 mm). The sealing force may be set up to 400 N, the heat sealing time to 1.24 s, pressing time to 1.9 s and Network pressure to 6 bar. Measurements were performed in triplicate for the best value and the maximum temperature of the machine is 550° C.

Sealing was performed by (1) sealing a coated surface of the substrate to a coated surface of the substrate (hot air sealing A-A: coated side-coated side), or (2) sealing a coated surface of the substrate to a non-coated (raw) surface of the substrate (hot air sealing A-B: coated side-back side).

### Hot Clamp Sealing

Hot clamp sealing was performed on a Kopp Laboratory Sealer SGPE 3000 from the company Kopp (Reichenbach, Germany) equipped with sealing bar of 200×5 mm. The temperature was set up in a range of 90 to 160° C., with a sealing force of 100 N (0.4 N/mm²) and a time of sealing of 0.5 seconds.

### Seal Strength

Seal strength of the seal layer obtained by hot clamp sealing was measured with L&W Tensile test from the company Lorentzen & Wettre (Sweden) by an unsupported T-peel test using a test specimen having a 50 mm width. Seal strength at sealing break (peeling) were reported in Newton [N].

### 2. Materials

### 2.1 Exemplary Embodiments Exemplary Embodiments of Polymer a, Polymer B, and the Optional Wax

The following polymer mixes may be used in accordance with this invention:

### Polymer Mix 1:

Aqueous dispersion of neutralized ethylene/acrylic acid polymer (polymer A; CAS: 9010-77-9). Polymer A has a comonomer content of acrylic acid of about 20 mol-%; solid content 40.0 wt. %; pH (ISO 976:2013) 8.5; Viscosity (ISO 1652:2011) 350±200 mPa*s.

### Polymer Mix 2:

Aqueous dispersion of neutralized acrylate/acrylic acid polymer (Polymer B; CAS: 51981-89-6); solid content 52.0 wt. %; pH (ISO 976:2013) 8.0; Viscosity (ISO 1652:2011) 250±100 mPa*s.

### Polymer Mix 3:

Aqueous dispersion of 90 wt. % (based on total dry solids) neutralized ethylene/acrylic acid polymer (polymer A; CAS: 9010-77-9) and 10 wt. % (based on total dry solids) of paraffin wax; solid content 40.0 wt. %; pH (ISO 976:2013) 8.5; Viscosity (ISO 1652:2011) 350±200 mPa*s. Polymer A has a comonomer content of acrylic acid of about 20 mol-%.

### Polymer Mix 4:

Aqueous dispersion of 90 wt. % (based on total dry solids) neutralized acrylate/acrylic acid polymer (first polymer; CAS: 51981-89-6) and 10 wt. % (based on total dry solids) of paraffin wax; solid content 51.0 wt. %; pH (ISO 976:2013) 8.0; Viscosity (ISO 1652:2011) 200±100 mPa*s.

### Exemplary Embodiment of the at Last One Pigment

Talc (Finntalc C15-B2, commercially available from Elementis, Finland; 63.5 wt. %, based on dry solids).

### Exemplary Embodiments of Pre-Coating Formulations:

### Pre1:

30 parts by weight of calcium carbonate (CC5; 27.2 wt. %, based on dry solids);
70 parts by weight of talc (Finntalc C₁₅-B2, commercially available from Elementis, Finland; 63.5 wt. %, based on dry solids);
10 parts by weight of binder (Litex PX 9460; 9.1 wt. %, based on dry solids);
0.2 parts by weight of rheology modifier (Rheocoat 35; available from Coatex, France; 0.2 wt. %, based on dry solids).

Solids content: 61.1 wt. %; pH: 8.9; viscosity (at 100 rpm): 660 mPa*s.

### Pre2:

50 parts by weight of calcium carbonate (CC5; 45.4 wt. %, based on dry solids);
50 parts by weight of talc (Finntalc C₁₅-B2, commercially available from Elementis, Finland; 45.4 wt. %, based on dry solids);
10 parts by weight of binder (Litex PX 9460; 9.1 wt. %, based on dry solids);
0.2 parts by weight of rheology modifier (Rheocoat 35, available from Coatex, France; 0.2 wt. %, based on dry solids).

Solids content: 61.1 wt. %; pH: 8.9; viscosity (at 100 rpm): 840 mPa*s.

### Exemplary Embodiments of Substrates:

### Raw Paper:

Paper, 35 mottled, White (WTL), available from Visy Industries Holdings Pty Ltd, Australia (Grammage 184 g/m², Thickness 222 μm, Bulk 1.20 cm³/g, Density 0.83 g/cm³, PPS 4.91 μm, Roughness Bendtsen 267 mL/min, Air resistance Gurley 65.4 sec./100 cm³, Air permeance Bendtsen 173.7 mL/min).

### Pre1-Paper:

Raw paper coated with pre-coating formulation Pre1 (coating weight: 6.3 g/m²).

### Pre2-Paper:

Raw paper coated with pre-coating formulation Pre2 (coating weight: 6.4 g/m²).

### 2.2 Examples

### 2.2.1 Materials

### Polymer Mix 3:

Aqueous dispersion of 90 wt. % (based on total dry solids) neutralized ethylene/acrylic acid polymer (polymer A; CAS: 9010-77-9) and 10 wt. % (based on total dry solids) of paraffin wax; solid content 40.0 wt. %; pH (ISO 976:2013) 8.5; Viscosity (ISO 1652:2011) 350±200 mPa*s. Polymer A has a comonomer content of acrylic acid of about 20 mol-%.

### Polymer Mix 4:

Aqueous dispersion of 90 wt. % (based on total dry solids) neutralized acrylate/acrylic acid polymer (first polymer; CAS: 51981-89-6) and 10 wt. % (based on total dry solids) of paraffin wax; solid content 51.0 wt. %; pH (ISO 976:2013) 8.0; Viscosity (ISO 1652:2011) 200±100 mPa*s.

### Filler 1:

Kaolin clay, commercially available as Hydragloss 90; particle size distribution: volume-median particle size d₅₀ (wet measurement; Mastersizer 3000)=0.21 μm, volume top cut particle size d₉₈=1 μm; specific surface area (BET)=20.5 m²/g.

### Filler 2:

Silicate, commercially available from Fluka; particle size distribution: volume-median particle size d₅₀ (wet measurement; Mastersizer 3000)=23 μm, volume top cut particle size d₉₈=52 μm; specific surface area (BET)=>400 m²/g.

### Filler 3:

Hydromagnesite; particle size distribution: volume-median particle size d₅₀ (wet measurement; Mastersizer 3000)=9.2 μm, volume top cut particle size d₉₈=33 μm; specific surface area (BET)=41.4 m²/g.

### Filler 4:

Barite; particle size distribution: volume-median particle size d₅₀ (wet measurement; Mastersizer 3000)=27 μm, volume top cut particle size d₉₈=113 μm; specific surface area (BET)=1.9 m²/g.

### Filler 5:

Perlite; particle size distribution: volume-median particle size d₅₀ (wet measurement; Mastersizer 3000)=3.0 μm, volume top cut particle size d₉₈=7.4 μm; specific surface area (BET)=2.4 m²/g.

### Filler 6:

Titanium dioxide; particle size distribution: volume-median particle size d₅₀ (wet measurement; Mastersizer 3000)=0.4 μm, volume top cut particle size d₉₈=2 μm; specific surface area (BET)=9.6 m²/g.

### Filler 7:

Surface-reacted calcium carbonate prepared by reacting a ground calcium carbonate with phosphoric acid; commercially available from Omya; particle size distribution: volume-median particle size d₅₀ (wet measurement; Mastersizer 2000)=6.6 μm; specific surface area (BET)=53 m²/g.

### Filler 8:

Aluminum oxide; particle size distribution: volume-median particle size d₅₀ (wet measurement; Mastersizer 3000)=102.5 μm, volume top cut particle size d₉₈=199 μm; specific surface area (BET)=126 m²/g.

### Substrate:

### Pre-3 Paper:

Coated paper prepared by pre-coating a raw paper commercially available from Hamburger Rieger GmbH (grammage=125 g/m²; roughness PPS 1.0 soft FS=7.85 μm, roughness PPS 1.0 soft WS=7.17 μm) with pre-coating formulation pre2 (coating weight=8 g/m²).

Examples and a comparative example of the aqueous coating composition and papers coated therewith are shown in Tables 1 and 2 below.

TABLE 1
Coating compositions and properties of coated papers

| Example | CE1 | IE1 | IE2 | IE3 | IE4 | IE5 | IE6 | IE7 | IE8 |
|---|---|---|---|---|---|---|---|---|---|
| Paper substrate | Pre3- | Pre3- | Pre3- | Pre3- | Pre3- | Pre3- | Pre3- | Pre3- | Pre3- |
| | paper | paper | paper | paper | paper | paper | paper | paper | paper |
| Aqueous coating | | | | | | | | | |
| composition¹ | | | | | | | | | |
| Polymer mix 4 | 24 | 24 | 24 | 24 | 24 | 24 | 24 | 50 | |
| Polymer mix 3 | 77 | 77 | 77 | 77 | 77 | 77 | 77 | 50 | |
| Filler 1 | | 8 | | | | | | | |
| Filler 2 | | | 8 | | | | | | |
| Filler 3 | | | | 8 | | | | | |
| Filler 4 | | | | | 8 | | | | |
| Filler 5 | | | | | | 8 | | | |
| Filler 6 | | | | | | | 8 | | |
| Filler 7 | | | | | | | | 8 | |
| Filler 8 | | | | | | | | | 8 |
| Solid content | 39.6 | 42.8 | 42.4 | 42.1 | 43.0 | 43.2 | 42.5 | 42.7 | 42.9 |
| pH | 9.9 | 9.0 | 8.8 | 9.8 | 8.9 | 8.9 | 8.9 | 8.9 | 9.0 |
| Viscosity (@ 100 rpm) | 1090 | 220 | 630 | 350 | 240 | 260 | 200 | 170 | 240 |
| Coated papers | | | | | | | | | |
| Coating weight (g/m²) | 9.5 | 9.2 | 10.6 | 9.1 | 9.7 | 10.2 | 10.3 | 9.1 | 8.7 |
| WVTR (23° C./50% RH; after | 21.6 | | 16.7 | 13.4 | 14.2 | 12.9 | 15.1 | 14.0 | 13.5 |
| 24 h) [g/m²*day] | | | | | | | | | |
| COBB 1800 (g/m²) | 22.6 | 16.1 | 11.7 | 11.9 | 9.9 | 10.0 | 10.4 | 15.0 | 10.9 |
| COBB 180 (g/m²) | 1.3 | 3.0 | 1.3 | 1.0 | 0.5 | 0.3 | 0.3 | 0.6 | 0.3 |
| Hot air sealing A-A (° C.)² | n.d. | 370 | 240 | 400 | 370 | 370 | 370 | 330 | 370 |
| | | (4/5) | (5) | (4/5) | (4.5/5) | (4.5) | (4) | (5) | (4.5/5) |
| Hot air sealing A-B (° C.)² | n.d. | 500 | 390 | 500 | 490 | 500 | 430 | 350 | 500 |
| | | (4/5) | (4.5/5) | (3) | (4.5/5) | (5) | (5) | (3) | (4/5) |

¹Amounts are indicated in dry parts by weight.
²Adhesion value after sealing in parenthesis: 0 = no seal; 1 = weak adhesion; 2 = adhered but no fibre tear; 3 = under 50% fibre tear; 4 = over 50% fibre tear; 4.5 = over 90% fibre tear; 5 = 100% fibre tear.

TABLE 2
Hot clamp sealing

| | | | | | | | | | |
|---|---|---|---|---|---|---|---|---|---|
| Sealing | | | | | | | | | |
| temperature | | | | | | | | | |
| [° C.] | CE1 | IE1 | IE2 | IE3 | IE4 | IE5 | IE6 | IE7 | IE8 |

Sealing A-A

| | | | | | | | | | | |
|---|---|---|---|---|---|---|---|---|---|---|
| 90 | Breaking | 10.0 | 11.7 | 12.9 | 10.8 | 14.4 | 13.0 | 12.6 | 10.4 | 12.5 |
| 100 | force [N] | 10.6 | 12.6 | 10.7 | 12.7 | 16.4 | 13.2 | 15.1 | 12.4 | 14.0 |
| 110 | | 11.9 | 13.8 | 14.4 | 12.5 | 14.4 | 14.9 | 14.4 | 14.2 | 15.5 |
| 120 | | 9.9 | 13.4 | 15.1 | 13.7 | 16.0 | 14.8 | 14.0 | 13.3 | 15.0 |
| 130 | | 10.6 | 13.6 | 16.1 | 13.9 | 16.1 | 14.1 | 13.8 | 14.5 | 15.8 |
| 140 | | 9.9 | 15.1 | 14.3 | 12.1 | 16.9 | 14.5 | 15.4 | 13.2 | 16.1 |
| 150 | | 11.1 | 15.3 | 15.7 | 14.3 | 15.9 | 15.5 | 15.6 | 13.6 | 15.7 |
| 160 | | 11.4 | 14.8 | 14.9 | 14.5 | 16.3 | 13.1 | 15.9 | 13.9 | 15.9 |

Sealing A-B

| | | | | | | | | | | |
|---|---|---|---|---|---|---|---|---|---|---|
| 90 | Breaking | * | 5.7 | 6.4 | * | 8.3 | 6.3 | 9.3 | 4.3 | 7.4 |
| 100 | force [N] | * | 5.7 | 7.8 | * | 9.4 | 9.5 | 8.7 | 7.1 | 8.6 |
| 110 | | * | 9.1 | 8.3 | * | 12.4 | 11.6 | 10.3 | 8.2 | 9.0 |
| 120 | | * | 11.3 | 9.4 | * | 12.8 | 11.8 | 11.3 | 10.3 | 11.8 |
| 130 | | * | 10.5 | 12.0 | 7.6 | 12.8 | 11.3 | 11.3 | 10.5 | 11.7 |
| 140 | | * | 10.9 | 10.1 | 7.4 | 11.5 | 12.3 | 11.6 | 9.5 | 10.2 |
| 150 | | * | 11.2 | 12.1 | 8.2 | 10.8 | 11.6 | 11.8 | 10.0 | 9.6 |
| 160 | | * | 10.5 | 10.6 | 7.7 | 10.1 | 11.5 | 10.1 | 8.7 | 10.1 |

* no sealing was obtained between the surfaces; the surfaces only showed an adhesion which was easily broken without fiber tear.

As can be seen from the results in Table 2, examples IE1 to IE8 show higher breaking force compared to the comparative example at the same temperature. Therefore, papers coated with the inventive coating can advantageously be sealed a desired sealing strength at a lower temperature which saves energy and/or allows for operating the sealing machine at higher speeds.

1. An aqueous coating composition comprising
(a) a polymer A comprising units derived from an alpha-olefin and one or more comonomers selected from the group of methacrylates, acrylates, methacrylic acid, acrylic acid, maleates, maleic acid, maleic anhydride, and salts thereof;
(b) a polymer B comprising units derived from one or more monomers selected from the group of methacrylates, acrylates, methacrylic acid, acrylic acid, maleates, maleic acid, maleic anhydride, and salts thereof;
(c) at least one pigment in an amount in the range of 0.1 to 30 wt. %, based on the total dry weight of the coating composition, wherein the at least one pigment is selected from the group consisting of clay minerals, silicates, brucite, magnesium carbonate, barite, perlite, satin white, gypsum, aluminum oxide, titanium dioxide, surface-reacted calcium carbonates, and mixtures thereof; and
(d) optionally a wax.

2. The aqueous coating composition according to claim 1, wherein the at least one pigment is at least one pigment selected from the group of phyllosilicates and combinations thereof, or
wherein the at least one pigment is at least one surface-reacted calcium carbonate.

3. The aqueous coating composition according to claim 1, wherein the surface-reacted calcium carbonate is a reaction product of natural ground calcium carbonate or precipitated calcium carbonate, and
wherein one or more H₃O⁺ ion donor is selected from the group consisting of hydrochloric acid, sulphuric acid, sulphurous acid, phosphoric acid, citric acid, oxalic acid, acetic acid, formic acid, and mixtures thereof.

4. The aqueous coating composition according to claim 1, wherein the aqueous coating composition comprises polymer A and polymer B in a weight ratio of 50:50 to 99:1.

5. The aqueous coating composition according to claim 1, wherein the aqueous coating composition comprises polymer A and polymer B in a weight ratio of >65:<35 to 99:1.

6. The aqueous coating composition according to claim 1, wherein the aqueous coating composition comprises 60 to 99.9 wt. % of a combined amount of polymers A and B, based on the total dry weight of the coating composition.

7. The aqueous coating composition according to claim 1, wherein the aqueous coating composition comprises the at least one pigment in an amount of 0.1 to below 20 wt. %, based on the total dry weight of the coating composition.

8. The aqueous coating composition according to claim 1, wherein the aqueous coating composition comprises:
(a) 50 to 99 parts per weight of polymer A,
(b) 1 to 50 parts per weight of polymer B,
(c) 1 to 30 parts per weight of the at least one pigment, and
(d) optionally 1 to 15 parts per weight of wax.

9. The aqueous coating composition according to claim 1, wherein
the polymer A comprises units derived from an alpha-olefin, and one or more monomers selected from the group of methacrylates, acrylates, methacrylic acid, acrylic acid, and salts thereof, and/or
the polymer B comprises units derived from one or more monomers selected from the group of methacrylates, acrylates, methacrylic acid, acrylic acid, and salts thereof.

10. The aqueous coating composition according to claim 1, wherein the polymer A is a copolymer of ethylene and acrylic acid.

11. The aqueous coating composition according to claim 1, wherein the polymer B is a polymer of acrylic acid and from one to three C₁-C₆ alkyl acrylate and/or C₁-C₆ alkyl methacrylate monomers.

12. The aqueous coating composition according to claim 1, wherein polymer A has a comonomer content in the range from 0.5 to 25 mol-%.

13. The aqueous coating composition according to claim 1, wherein the wax is a hydrocarbon wax.

14. The aqueous coating composition according to claim 1, wherein
the aqueous coating composition has a solids content in the range of 5 to 70 wt. % and/or
the aqueous coating composition has a pH value in the range of 7.5 to 12.

15. A process for preparing the aqueous coating composition according to claim 1, comprising the steps of:
providing an aqueous composition I comprising polymer A and optionally a wax,
providing an aqueous composition II comprising polymer B and optionally a wax,
providing the at least one pigment,
mixing the aqueous compositions I and II and the at least one pigment.

16. A coated article comprising a substrate, wherein at least one surface of the substrate comprises a coating prepared from an aqueous coating composition according to claim 1.

17. The coated article according to claim 16, wherein the substrate is a cellulose-based substrate, a plastic or a metal.

18. The coated article according to claim 16, wherein the coated article comprises a pre-coating between the at least one surface of the substrate and the coating,
wherein the pre-coating comprises at least one mineral and a binder.
